(19) United States
(12) Patent Application Publication
(10) Pub. No.: US 2025/0299169 A1
(43) Pub. Date: Sep. 25, 2025

(54) TOKEN-BASED EMAIL AUTHENTICATION FOR SECURE PEER-TO-PEER FINANCIAL TRANSACTIONS WITHOUT USER LOGIN

(71) Applicant: SWOOP IP HOLDINGS LLC, Wilmington, DE (US)

(72) Inventors: James KASSEMI, Albuquerque, NM (US); Dave WALZ-BURKETT, Albuquerque, NM (US); Chad PERSON, Albuquerque, NM (US)

(73) Assignee: SWOOP IP HOLDINGS LLC, Wilmington, DE (US)

(21) Appl. No.: 19/229,906

(22) Filed: Jun. 5, 2025

Related U.S. Application Data
(63) Continuation of application No. 15/604,193, filed on May 24, 2017, now abandoned.
Application No. 15/604,193 is a continuation of application No. 14/216,256, filed on Mar. 17, 2014, now abandoned.
(60) Provisional application No. 61/794,675, filed on Mar. 15, 2013.

(51) Int. Cl. G06Q 20/10; G06Q 20/02; G06Q 20/32; G06Q 20/38

(52) U.S. Cl. CPC G06Q 20/10; G06Q 20/027; G06Q 20/102; G06Q 20/3255; G06Q 20/382

(57) ABSTRACT

A system and method are disclosed for enabling secure and low-friction peer-to-peer financial transactions using email communication without requiring user login. A payment server receives an email message from a responder that includes a token embedded in a mailto hyperlink. The server extracts and decodes the token to retrieve transaction data, including the responder's email address and a transaction amount. The server authenticates the responder by comparing the email address extracted from the token with the sender address of the email. Upon successful validation, the server initiates a financial transaction with a payment processing system—without requiring the responder to access a login page, enter credentials, or navigate to a website. The invention improves upon conventional browser-based payment workflows by reducing user interaction and enhancing transaction efficiency and security.

### CROSS REFERENCE TO RELATED APPLICATIONS

This application is a Continuation of U.S. patent application Ser. No. 15/604,193 filed May 24, 2017, which is a Continuation of U.S. patent application Ser. No. 14/216,256 filed Mar. 17, 2014 (abandoned), which claims the benefit of U.S. provisional application No. 61/794,675, filed on Mar. 15, 2013, which are incorporated by reference as if fully set forth.

### FIELD OF INVENTION

The present invention is related to electronic payment systems.

### BACKGROUND

Some email-based payment methods require cumbersome web-based authentication processes to complete a transaction. This requires the user to have an active internet connection or the transaction may typically not be completed. As mobile devices are used for a greater percentage of online transactions, this may present a problem since mobile or wireless internet access may be less reliable than wired access. Many users have their applications and accounts attached to more than one device. Current electronic payment systems may be cumbersome when utilized on mobile devices. There is a need for a method for making transactions that may be easily shared on devices from desktop, laptop, tablet, smartphone and mobile phones. Email is the perennial application that is shared and is the assumption of most of these devices. Virtually every online application requires an email address as the basis for signing up.

Individuals that need to collect money from large groups of people need a tool that is fast and easy to use and is designed for the nonprofessional. Small organizations, community groups, churches and families may not have the capacity to make a website with a payment page. These types of organizations may require an accessible tool for collecting and sending money. Many of these groups already organize communication through group email lists. A tool that enables the sending of a single email message to multiple users requesting payment may be a convenience. The capacity to request or send money from multiple recipients may be welcomed in the marketplace.

The driver of online monetary transactions is businesses collecting money from individual customers. Most individual customers have payment accounts with businesses that allow for transactions to happen in an expedited manner. These transactions are either a one-time transaction or an on-going registration. Although many businesses allow customers to register accounts and submit payments these accounts only allow for the transfer of funds in a single direction. They do not allow the customer to accept money and this is a logical outcome based on a perspective that the vendor provides the payment service. A vast population of online consumers register to pay money but not to receive money because it is a convenience provided by the vendor. As an alternative if the payment tool is provided by the customer and the network to which they are associated with new functional possibilities arise. Systems like PayPal integrate across vendors. However all of these methods are dependent on making payments on URL pages. In order to do any of these processes the users must already have an email account. As a number of registered email based transactions grow the integration of those users into a single connected network may be desired. Giving individual members the same abilities as the vendor may be desired.

There are numerous ways to send money and receive money through electronic messaging. PayPal and Western Union are examples of how to send money directly to an individual's bank account. In all of these systems there are inherent distinctions between businesses and individual users. How a user may interface with a business may vary from how individuals correspond with each other. Although all of these systems may utilize email messages to send receipts and status updates, they use URLs in order to submit the transaction. Organizing a social network of users based on their email accounts may be welcome in the market place. Designing a system where monetary transactions may be performed by email and a user receives updates on payment requests may eliminate the complicated setups and plugins that are required on web-based transactions. This web-based transaction may be replaced by a one-time sign up and the capacity to request payments with no fee and no integration of systems. Password secured email accounts may serve an additional function as a secure site to approve transactions eliminating redundant login information.

In an effort to expedite checkout many vendors may try and register an individual as a customer and store credit card information and delivery instructions so as to allow the user to skip many cumbersome steps. They may also use other plugins on the checkout page where the customer is already registered with a payment service. Both nonprofits and businesses promote their organizations through email advertising campaigns. Many customers also receive updates and invoices through email but are ultimately driven to web URLs to complete transactions. Businesses and nonprofits may benefit from an payment service that may allow customers to respond directly to an offer by sending the email with no need for a username or password. This may eliminate steps in the process of purchasing or donating. Being able to identify users with this ability may be to an organization's advantage in the marketplace. At the same time, it allows the customer to share the offer within that payment network. Vendors and nonprofits may welcome the new customer base that has access to the email payment gateway and create offers that incentivize the sharing and promotion of those deals with the community of the email payment gateway.

Sending money to a daughter in college, collecting money for a baseball team, buying clothes on target.com and paying rent all represent different levels of sending money. Each of them has a different way of making the payment. A payment method that may unify all of these methods into a single field in which all of the actors may participate in a network may be ideal. Although participation in many social networks vary and many automated payment systems limit their vendors, virtually all of these actors have email accounts as a given of online life. Forming a network of users that is based in an email payment system and that exploits the social interactions may be welcome in the market place. An email based financial transaction for individuals to send and receive money is the next logical step.

### SUMMARY

The system described herein may comprise a network that allows registered individual customers to make financial transactions using email payment gateway. Registered individuals and organizations may send and receive payments from other members within the network with credit/debit cards and bank account information. Payments may be made by responding to emails. This network permits individuals and organizations to register and use the email payment gateway through online sign up without the need for a business to business integration. This allows both the sending and receiving of money to any member in the network. It also allows registered users to send a group email with the capacity for all of those recipients to pay them in email based responses. This allows for a similar functionality as email campaign management systems like MAILCHIMP or CONSTANT CONTACT but with the ability to do transactions built in. In this embodiment the email payment technology may take on aspects of social networking allowing for profile and public pay pages that may let campaigns and offers go viral. An offer from a vendor or individual may travel the network by virtue of the community's social interactions.

A method for peer-to-peer e-commerce transaction between a first user and a second user that is facilitated by a payment server is disclosed. The method including receiving a money request from a first user, wherein the money request identifies a second user from which money is requested. The method further including transmitting a money request email message to the second user, wherein the money request email includes a token and receiving a response email message to the money request email message, wherein the response email message includes the token. The method further including determining whether the second user is a member based on the received token and an email address associated with the response email message.

### BRIEF DESCRIPTION OF THE DRAWINGS

A more detailed understanding may be had from the following description, given by way of example in conjunction with the accompanying drawings wherein:

FIG. 1 shows an example of a block diagram for a system for peer to peer email based financial transactions;

FIG. 2 is a flow diagram for a peer to peer money request and sign up using an URL-Targeted Token;

FIG. 3 is a transactional flow diagram for a method for requesting money from an unregistered responder using an URL-Targeted Token;

FIG. 4 is a transactional flow diagram for a method for requesting money from a registered responding member using an URL-Targeted Token;

FIG. 5 is a transactional flow diagram for a method for sending money for a registered responding member using an email-targeted token;

FIG. 6 is a transactional flow diagram for a method for sending money for a unregistered responding member using an email-targeted token;

FIG. 7 is an example web page for signing up with the payment server 140;

FIG. 8 shows an example web page for accessing the quick send feature;

FIG. 9 shows an example web page for viewing the email blaster preview;

FIG. 10 shows an example web page for viewing a user dashboard, where a member may see the status of campaigns;

FIG. 11 shows an example web page for accessing a user's pay page;

FIG. 12 shows an example web page for a generating quick request;

FIG. 13 shows an example web page for accessing a user's account settings;

FIGS. 14A-14C show an example web page 1400 for generating an email blast; and

FIG. 15 shows an example web page for an embodiment where the payment server is integrated with an email server.

### DETAILED DESCRIPTION

When used herein, the term “token” may refer a string or file used to authenticate a transaction. A token may be one or multiple encrypted strings, files, passwords, cyphers or other data which may contain information used to perform or authenticate a transaction when sent to payment servers. These tokens may be encrypted using a public-private key encryption system. The vendor or a party with knowledge of the vendor's private key may generate an encrypted token. Alternatively, a payment system or e-commerce site may generate this token on behalf of the vendor.

When used herein, the term “member” may refer to a person that is a registered with an account.

When used herein, the term “individual” may refer to people that are online.

When used herein, the term “initiator” may refer to a member that starts a transaction by contacting one or more recipients.

When used herein, the term “responder” may refer to a recipient that responds to a communication from an initiator regarding the transaction.

When used herein, the term “transaction request” may refer to a general term for receiving money or sending money.

When used herein, the term “email-targeted token” may refer to a token associated with a specific email address.

When used herein, the term “URL-targeted token” may refer to token not associated with a specific email address and that may be forwarded and used by other members.

When used herein, the term “pay page” may refer to a publicly accessible web page where individuals may make payments to members.

Disclosed herein are processor-executable methods, computing systems, and related technologies for peer to peer email based financial transactions. While the technologies described herein are discussed using e-mail as an example, they may also be applicable to similar communication mediums, such as SMS and MMS communication channels.

The peer to peer system described herein allows the payment server 140 to allow individual members the same ability to collect money as well as pay vendors. Members may quickly send each other money with minimum information. Members get a publicly accessible web page for receiving payments. Members may send their own email campaigns with the ability to send and collect money. Members may socialize and share offers.

As described hereinafter in greater detail, the system described herein allows a user to create a profile that has a public pay page. A user may generate a quick request for money in its simplest form with only two input fields. This user may be a member that is registered with an e-commerce website. A user may generate a quick send message to send money in its simplest form with only two input fields. A user may use an email blaster feature to design and send an email requesting money with multiple amounts, graphics, and buttons to one or multiple individuals. When a request to send out an email blast is received, the system may generate a type of email for members and a different type of email for non-members. A user may respond to other solicitations. For example, if the user is a member, they may respond directly using an email message and may not need to login whereas a nonmember user may be directed to an URL which asks them to register and/or login. A user may maintain email address book and email campaigns. A user may monitor email campaign responses. A user may schedule payments and reminders. A user may schedule email reminders to themselves with response mailto hyperlinks that let the user maintain the account from email. A user may select an interface that adapts the system to being more geared to a payroll or invoicing system. The system may be configured for competitive bidding or limited time offers that monitor quantities or expiration dates that members respond to as individuals or as communities.

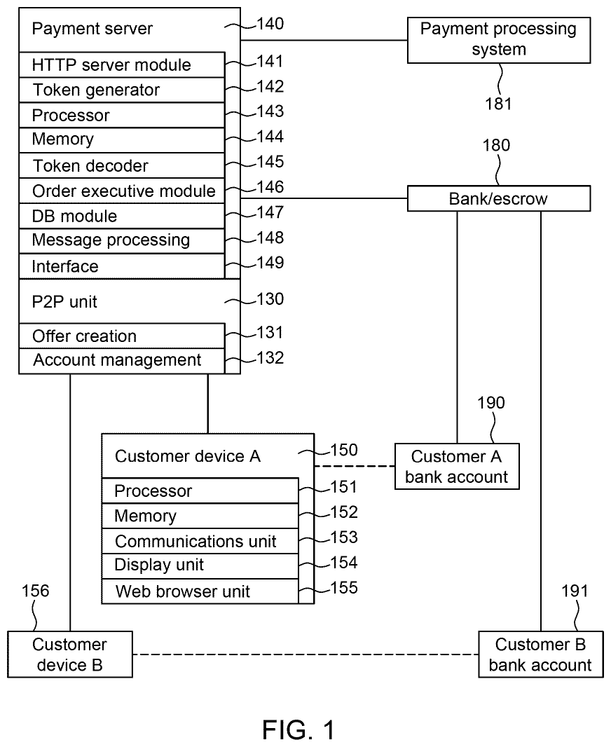

FIG. 1 shows an example system 100 that may be utilized for e-commerce financial transactions. The example system 100 includes multiple customer devices 150 and 156, a payment server 140 that may be operatively connected to a peer to peer unit 130, multiple customer bank accounts 190 and 191, a bank/escrow server 180 and a payment processing system 181, each of which may communicate over one or more wired and/or wireless networks. The wired or wireless networks may be public, private or a combination of public or private networks.

The customer devices 150 and 156 may be, for example, a cellular phone, a smartphone, a desktop computer, a laptop computer, a tablet computer, or any other appropriate computing device. As shown in FIG. 1, the customer device 150 that is associated with customer A includes a processor 151, memory 152, a communications unit 153, a display unit 154 and web browser unit 155, which may communicate data to/from the web server module(s) in the vendor server 120 and payment server 140. The web browser unit 155 may include and/or communicate with one or more sub-modules that perform functionality such as rendering HTML (including but not limited to HTML5), rendering raster and/or vector graphics, executing JAVASCRIPT, and/or rendering multimedia content. While not shown in FIG. 1, the customer device 156 associated with customer B may contain the same or similar components.

Alternatively or additionally, the web browser unit 155 may implement Rich Internet Application (RIA) and/or multimedia technologies such as ADOBE FLASH and/or other technologies compatible with Internet based communications. The web browser unit 155 may implement RIA and/or multimedia technologies using one or web browser plug-in modules (e.g., ADOBE FLASH), and/or using one or more sub-modules within the web browser unit 155 itself. The web browser unit 155 may display data on one or more display devices (not depicted) that are included in or connected to the customer device 150, such as a liquid crystal display (LCD) display or monitor. The customer device 150 may receive input from the user of the customer device 150 from input devices (not depicted) that are included in, or connected to, the customer device 150, such as a keyboard, a mouse, a microphone or a touch screen, and provide data that indicates the input to the web browser unit 155.

The payment server 140 may include an HTTP server module 141, a token generator 142, a processor 143, memory 144, a token decoder 145, an order execution module 146, a DB module 147, a message processing module 148, and an interface module 149.

The HTTP server module 141 provides a website that may be accessed by a customer device 150. The HTTP server module 141 may implement the HTTP protocol, and may communicate Hypertext Markup Language (HTML) pages and related data from the website to/from the customer device 150 using HTTP. The vendor server 120 may be connected to one or more private or public networks (such as the Internet), via which the HTTP server module 141 communicates with devices such as the customer device 150. The HTTP server module 141 may generate one or more web pages and may communicate the web pages to the customer device 150, and may receive responsive information from the customer device 150.

The HTTP server module 141 may be, for example, an APACHE HTTP server, a SUN-ONE Web Server, a MICROSOFT INTERNET Information Services (IIS) server, and/or may be based on any other appropriate HTTP server technology. The payment server 140 may also include one or more additional components or modules (not depicted), such as one or more load balancers, firewall devices, routers, switches, and devices that handle power backup and data redundancy.

The token generator 142 may generate tokens for use in e-commerce transactions. Tokens may be encrypted strings which contain information to perform transactions. A token may be one or multiple encrypted strings, files, passwords, cyphers or other data which may contain information used to perform or authenticate a transaction. A token may include one or more of the following parameters or other parameters not listed below:
a) private-key: The private key provided by the payment server 140.
b) public-key: Payment server's 140 public key, provided by the payment server 140.
c) partner-id: The partner ID given provided by the payment server.
d) environment: The environment the vendor wants to generate buttons for. This distinguishes whether the token is being used in a testing environment or in the live environment (and running real transactions).
e) config: The path to a configuration file in yml format. This may hold a default set of information, e.g., private_key, public_key, partner_id, and other information—so they don't have to be entered separately each time a token is generated. The configure field may also contain information specific to an offer (e.g. dollar amount) or a customer (e.g., card token) if multiple tokens are being generated with similar components.
f) type: The type of token to generate (site, email, universal). There are multiple types of tokens that a token generator may generate and decode. For example, site tokens may be used for website transactions, email tokens for two-click email payments, and universal tokens for email validations.
g) card: The card token associated with the recipient of this token. When a customer is registered with the payment server 140, the vendor receives a credit card token—a unique identifier that references the specific card associated with that customer and vendor. When the vendor is generating a token to submit to payment server 140, they may include the card token as a customer identifier.
h) email: The email associated with the receipt of this token.
i) URL: The Signup URL the recipient should go to if customer doesn't have payment information registered with payment server 140.
j) amount: The amount a user should be charged for the transaction the token is generated for.
k) user-data: Data to pass back as a reference. This data may include custom data that the vendor may want to pass through the payment server 140 and receive back when a transaction has completed. It may include an item reference number or SKU, customer address, or other piece of data that is not required by payment server 140 to complete a transaction, but that the vendor wants associated with that transaction.
l) expires: Expiration date for token, integer value of seconds since epoch.
m) header-user-agent: The HTTP_USER_AGENT from the request header. HTTP headers are sent as part of a request from a customer's web browser unit 155 for a piece of information. These headers define the parameters that the web browser unit 155 is expecting to get back. The user-agent is the identifier of the software that is submitting the request—typically the identifier of the web browser unit 155 that is requesting the content.
n) header-accept-language: The HTTP_ACCEPT_LANGUAGE from the request header. The accept-language is the acceptable language for the response—e.g. the language in which the web browser unit 155 is requesting the content be sent back.
o) header-accept-charset: The HTTP_ACCEPT_CHARSET from the request header. The accept-charset is the character sets that are acceptable for the response—e.g. the character set in which the web browser unit 155 is requesting the content be sent back.
p) ip-address: The IP address of the token recipient.

To confirm an e-commerce transaction via email, the customer sends an email embedded with a token to the payment server's 140 address. The system 100 is designed to allow the vendor flexibility to offer deals for a limited time or number or responsive to available inventory. For example, the token may be configured to expire by default after two weeks, or any predetermined time, or never expire.

The memory 144 may be configured to store information associated with e-commerce transactions. This may include inventory information, information used to generate web pages, customer information, and other e-commerce data.

The payment server 140 may also be in communication with the peer to peer (P2P) unit 130. The P2P unit 130 may comprise an offer creation unit 131 and an account management unit 132, and as described in greater detail hereafter, may facilitate P2P transactions.

The customer bank accounts 190 and 191 may be controlled by a third party system bank. The payment server 140 may communicate with the customer bank accounts 190 and 191 to verify that the customer has adequate funds or credit for the requested purchase. For example, the customer bank accounts 190 and 191 may be a controlled by VISA, AMERICAN EXPRESS, MASTERCARD or any other bank or banking or financial network that a customer may use for online payment. The customer bank accounts 190 and 191 may be a server for virtual currencies, such as BITCOIN, etc. While not shown in FIG. 1, customer bank accounts 190 and 191 may comprise a processor, memory, a communications unit, and network interface.

The system 100 may also comprise a bank/escrow server 180 to store funds in escrow during transactions. While not shown in FIG. 1, bank/escrow server 180 may comprise a processor, memory, a communications unit, and network interface. The bank/escrow server 180 may serve to serve as a third party holding location on behalf of transacting parties.

A payment processing system 181 may serve to facilitate transactions by performing payment processing duties. While not shown in FIG. 1, payment processing system 181 may comprise a processor, memory, a communications unit, and network interface.

As examples described below may use different types of tokens, an email-targeted token and URL-targeted (or shareable) tokens. These two are selected as examples, but other tokens may be used.

For email-target tokens, an initiator using a customer device 150 may compose an email request and add a list of recipients. When the initiator sends the email, the payment server 140 may determine which recipients are registered with payment server 140 and which are not. The payment server 140 may send two separate emails—one to members and one to non-members. The members get an email checkout with mailto hyperlinks and the non-members get a link to the URL pay page and a sign up. The mailto hyperlinks sent to members may contain a token for processing a two-click email checkout. The token may comprise an embedded identifier of the email address of the recipient (that is the intended responder), along with the other necessary information required to complete the transaction. The intended recipient/responder may send a response email, using e.g. customer device 156, to the payment server 140. If the response email contains the token, the payment server 140 decodes the token, confirms that the embedded email address matches the address the token was submitted from, and, assuming all checks pass, the payment server 140 processes the transaction. If an individual other than the intended recipient/responder returns the token to the payment server 140, the process may fail when the email address contained in the token is compared to the submitting email address. This individual may receive an error notification instructing them to complete their purchase by clicking on URL to a payment page on which they may fill out their payment information and simultaneously register for an account with the payment server 140.

For URL-targeted tokens (i.e. sharable tokens) the initiator, using a customer device 150, may compose an email request and adds the list of recipients. When the initiator sends the email campaign, the payment server 140 sends out an identical email to each recipient. Within this email is a mailto hyperlink, which contains a token for processing a two-click email checkout. This token contains necessary information required to complete the transaction, but it may not contain any identifier of the intended recipient/responder. If a member responds to the campaign, the payment server 140 recognizes the email address that is in the submitted email message (not in the token), reads the content of the token, and (if all other checks pass) processes the transaction. If the response is from a nonmember, the payment server 140 responds by sending an email with a URL link to the pay page of the initiator of the request. At that point the nonmember enters their payment information and completes the transaction.

URL-targeted tokens may be forwarded between individuals, it may be used by any member, and there is a built-in path for nonmembers to be directed to a URL at which they may complete a transaction.

In some embodiments, sending money may be processed differently than requesting money in regards to which token type is used. This may be for security reasons. For example, in sending money, the token used may be the email-targeted token. Whereas in requesting money, the email-targeted token and/or the URL-targeted token may be used.

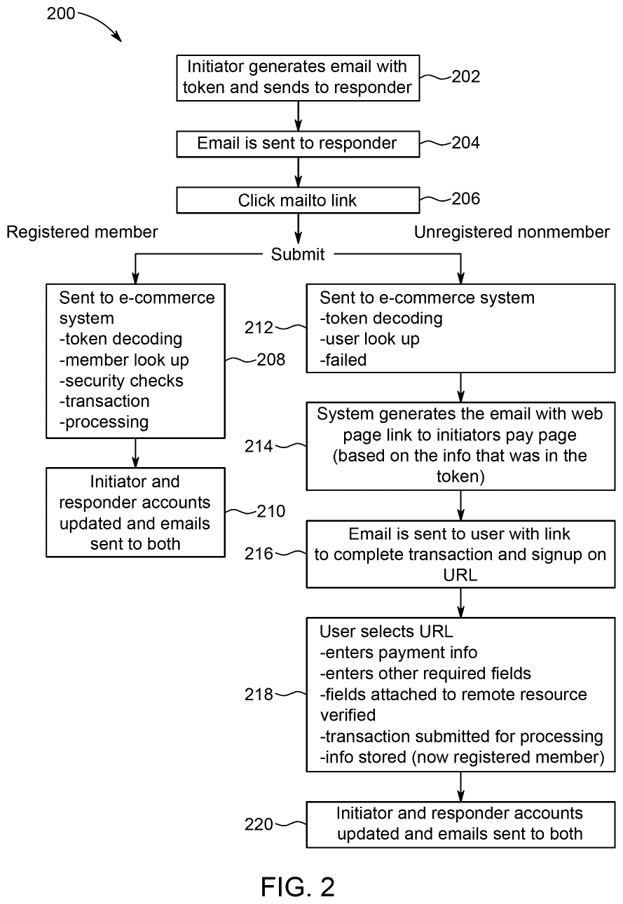

FIG. 2 is a flow diagram for a method 200 for a peer to peer money request and sign up using an URL-Targeted Token. An initiator generates an email with a token and send the email to the responder (step 202). In this scenario, the initiator may be using customer device 150 and the token may be embedded in a mailto hyperlink in the email message. The email is received by the responder, e.g., using customer device 156 (step 204). The responder, using customer device 156 may then click on the mailto hyperlink (step 206). The payment server 140 may receive this email message and determine whether the responder is a registered member or an unregistered member. If the users are registered members, the payment server 140 is able to decode the token, look up the member identification information, perform security checks, and process the transaction (208). Once the transaction is processed, the payment server 140 may then update the accounts for the initiator and responder and send email confirmations to both parties (210). If the responder is an unregistered member, the payment server 140 may still be configured to decode the token and perform a look up of member identification information (step 212). However, because the member identification lookup failed, the payment server 140 generates an email with a web page link to the initiators pay page (step 214). The payment server 140 sends an email to the unregistered nonmember; this email includes a link to complete the transaction and signup on a web page (step 216). The user may select the hyperlink embedded in the email; enter payment information along with additional registration fields allowing the payment server 140 to verify the information. The transaction is submitted for processing and the information regarding the user is stored (step 218). The payment server 140 updates the initiator and responder accounts and sends confirmation emails to both parties (step 220).

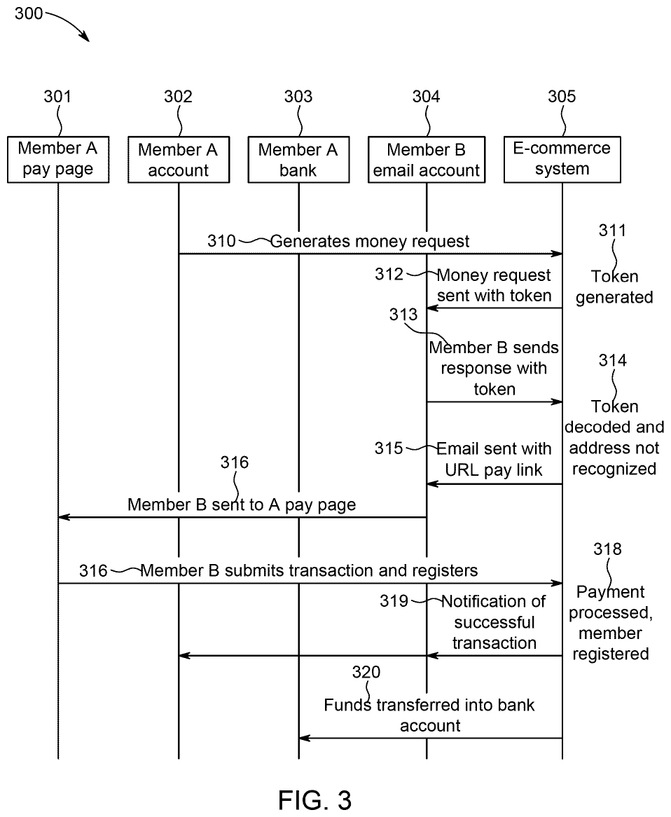

FIG. 3 is a transactional flow diagram for a method for requesting money from an unregistered responding user using URL-Targeted Token. In this example, a money request is generated from member A's account 302 which is sent to an e-commerce system 305 (step 310). Typically, this may be performed by a member accessing the account using a customer device 150. The e-commerce system 305 generates a token (step 311). The e-commerce system 305 sends the money request including the token to an email account 304 associated with member B (step 312). Member B, using customer device 156 sends a response email including a token to the e-commerce system 305 (step 313). As shown in FIG. 3, the e-commerce system 305 may decode the token and not recognize the address (step 314). In response, the e-commerce system 305 send an email including an URL pay link to an email account associated with member B (step 315). By selecting the URL pay link, member B is directed to a web page associated with member A (step 316). Member B, using e.g. customer device 156 may submit payment information and register with the payment server 140 from member A's web page 301 (step 316). The e-commerce system 305 receives this information, processes the payment and registers the user as a member (step 318). The e-commerce system 305 sends notifications of a successful transaction to member A and member B via their email accounts 302 and 304 (step 319). The e-commerce system 305 may then transfer funds into member A's bank account 303 (step 320). Payment server 140 may be an example of an e-commerce system 305 as used herein.

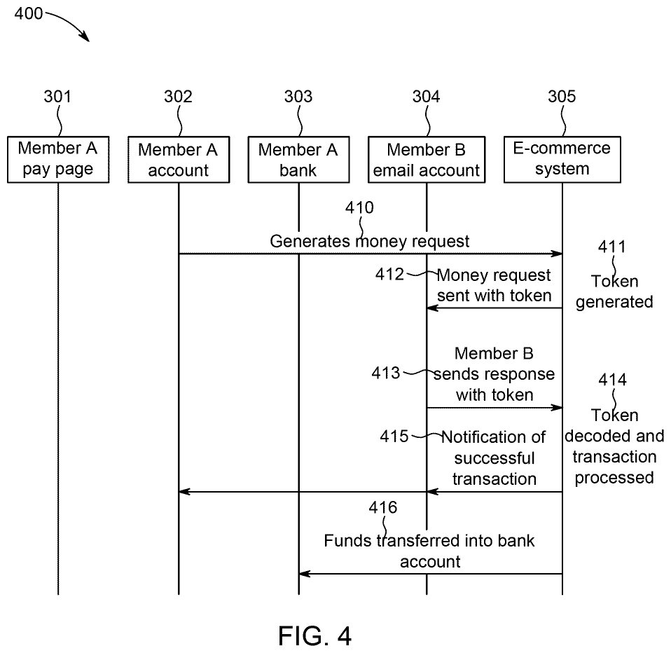

FIG. 4 is a transactional flow diagram for a method for requesting money from a registered responding member using an URL-Targeted Token. In this example, a money request is generated from member A's account 302 which is sent to an e-commerce system 305 (step 410). Typically, this may be performed by a member accessing the account using a customer device 150. The e-commerce system 305 generates a token (step 411). The e-commerce system 305 sends the money request including the token to an email account 304 associated with member B (step 412). Member B, using customer device 156 sends a response email including a token to the e-commerce system 305 (step 413). The e-commerce system 305 decodes the token and the transaction is processed. The e-commerce system 305 sends notifications of a successful transaction to member A and member B via their email accounts 302 and 304 (step 415). The e-commerce system 305 may then transfer funds into member A's bank account 303 (step 416).

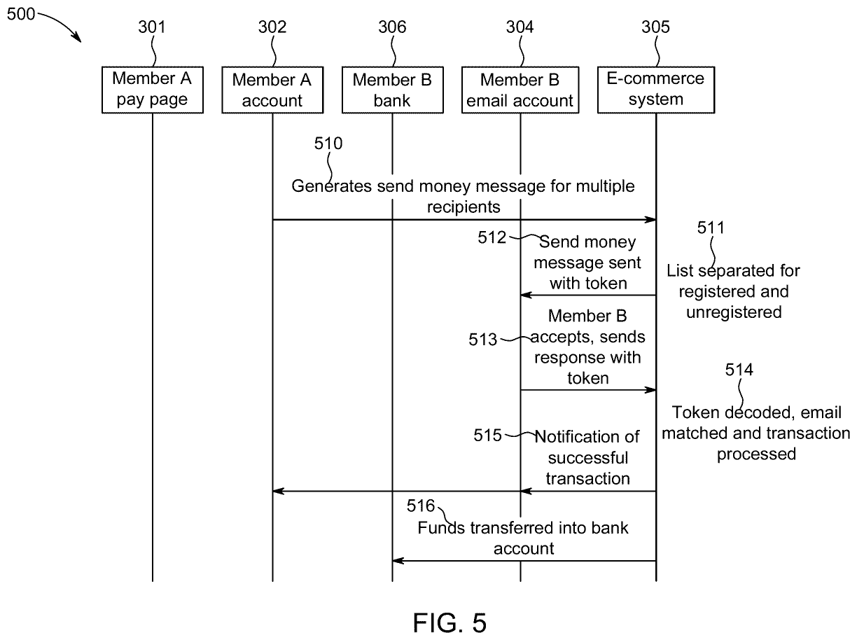

FIG. 5 is a transactional flow diagram for a method for sending money for a registered responding member using an email-targeted token. In this example, a money request is generated from member A's account 302 for multiple recipients which is sent to an e-commerce system 305 (step 510). Typically, this may be performed by a member accessing the account using a customer device 150. The e-commerce system 305 receives the message and determines which of the multiple recipients are registered and unregistered users (step 511). The e-commerce system 305 sends a money message with a token to an email account associated with member B (step 512). Member B, using a customer device 156 may accept the money message and send a response via email with an embedded token (step 513). The e-commerce system 305 may receive the email message, decode the token, match the email address with an email address associated with a member and process the transaction (step 514). The e-commerce system 305 sends notifications of a successful transaction to member A and member B via their email accounts 302 and 304 (step 515). The e-commerce system 305 may then transfer funds into member B's bank account 306 (step 516).

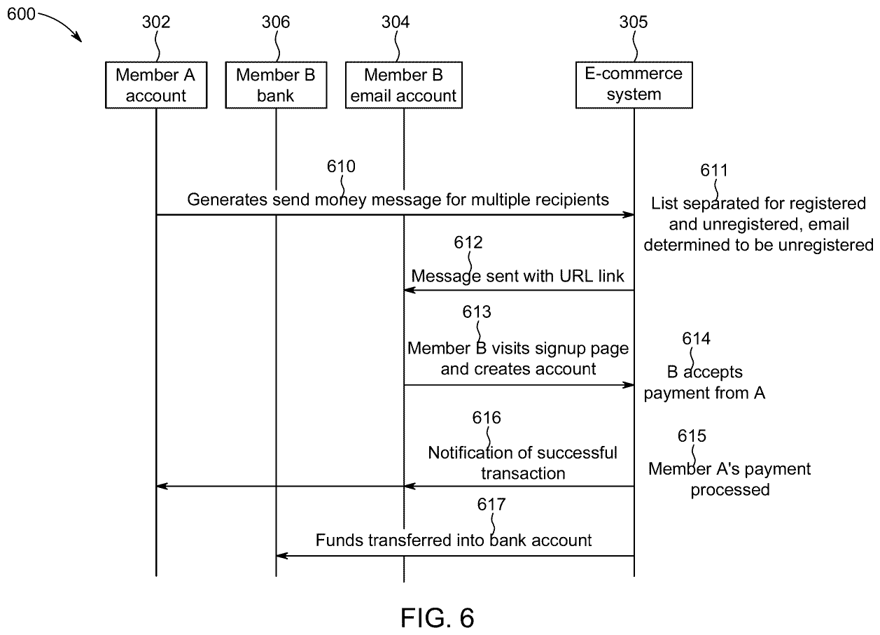

FIG. 6 is a transactional flow diagram for a method for sending money for an unregistered responding individual using an email-targeted token. In this example, a money request is generated from member A's account 302 for multiple recipients which is sent to an e-commerce system 305 (step 610). Typically, this may be performed by a member accessing the account using a customer device 150. The e-commerce system 305 receives the message and determines which of the multiple recipients are registered and unregistered users and the email may be determined to be from an unregistered user (step 611). The e-commerce system 305 sends a message with an URL link to an email account associated with member B (step 612). Member B, using a customer device 156 may visit a signup page and create an account with the e-commerce system 305 (step 613). The e-commerce system 305 may accept payment from A, once the recipient is registered (step 614). The e-commerce system 305 may process member A's payment (step 615). The e-commerce system 305 sends notifications of a successful transaction to member A and member B via their email accounts 302 and 304 (step 616). The e-commerce system 305 may then transfer funds into member B's bank account 306 (step 616).

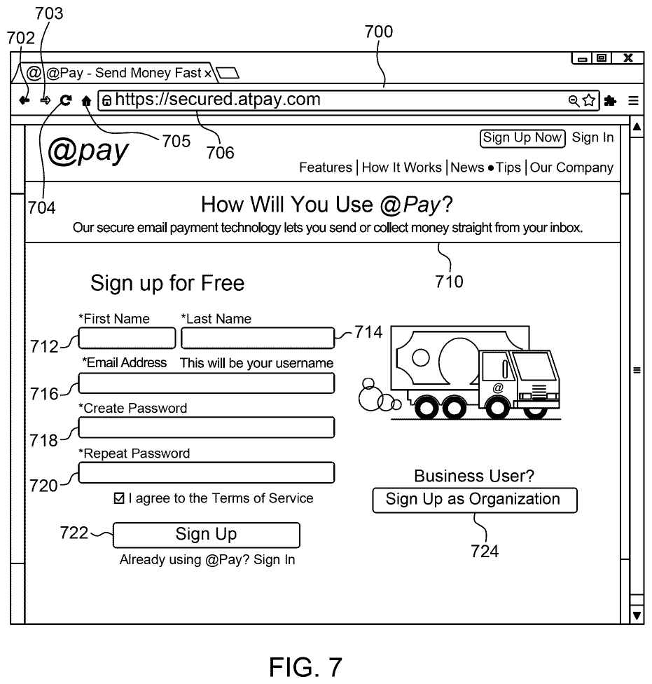

FIGS. 7-13 show example web pages that may be displayed by a web browser unit associated with a customer device 150 or 156. As will be described in detail below, the web pages may include display elements which allow initiators and responders to complete peer to peer email based financial transactions utilizing one or more emails. The web pages may be included in a web browser window that is displayed and managed by the web browser unit 155. The web pages may include data received by the web browser unit 155 from the payment server 140. The web pages may include payment transaction information.

The web browser window may include a control area 700 that includes a back button 702, forward button 703, refresh button 704, home button 705, and address field 706. The control area 700 may also include one or more additional control elements, such as bookmark page etc. An initiator or responder using a customer device 150 or 156 may select the control elements in the control area 700. The selection may be performed, for example, by clicking a mouse or providing input via keyboard, touch screen, and/or other type of input device. When one of the control elements is selected, the web browser unit 155 may perform an action that corresponds to the selected element. For example, when the refresh button 704 is selected, the web browser unit 155 may refresh the page currently viewed in the web browser window.

FIG. 7 is an example web page 710 for signing up with the payment server 140. A user registers online with the payment server 140 to send and receive payments using email messaging. The user visits or is directed to the payment server 140 web page 710 if they are not already registered they set up an account. As shown in FIG. 7, the web page may include multiple input fields 712-724. A user wishing to become a member and use the peer to peer payment features may be directed to the sign up web page 710. A user may access the web page 710 using a customer device 150 or 156, such as a laptop, smartphone, tablet, or other computer. A first time user of the peer to peer system may be taken to the sign up web page 710 if an unrecognized email address is submitted from a peer or an email is received from an unrecognized address. As the customer device 150 or 156 receives input for the input fields 712-724, the web browser unit 155 may store one or more data structures that reflect the selections made in the input fields. As shown in FIG. 7, the input fields 712-720 may comprise a first name field, a last name field, an email address field, a create password field and a repeat password field. Input field 722 as shown in FIG. 7 is a sign up button, to be selected by the user once input fields 712-720 are filled out. Input field 724 is a button to notify the payment server 140 that the new account is for a business user. Selecting input field 724 may take a user to another sign up web page with different input fields. Further, as the selections are updated, the web browser unit 155 may update the web page 710 to indicate additional, or more specific, questions that may be associated with the selections.

While not shown in FIG. 7, the user may also be prompted to provide credit card and bank account information or they may wait until they wish to retrieve funds. They user may also setup a profile page that includes a description of themselves and an avatar.

Once an individual is a member they are able to begin sending or receiving payments. Assuming they are logged into their member account, they may send email transaction requests to other individuals. A member may send a transaction request to one or many email addresses and those email addresses are stored in the profile page. A transaction request may be asking for money or sending money. When logged in their account the member may compose the content of the transaction request email and determine the email list of recipients. The email is sent from there. In the original design, the system sent an email message containing the details of the request, instructions on how to complete the transaction and at least one mailto hyperlink associated with the transaction amount to registered members or a URL link to a pay page for unregistered individuals. With the URL Targeted Token, all users may receive a mailto hyperlink for generating a response email.

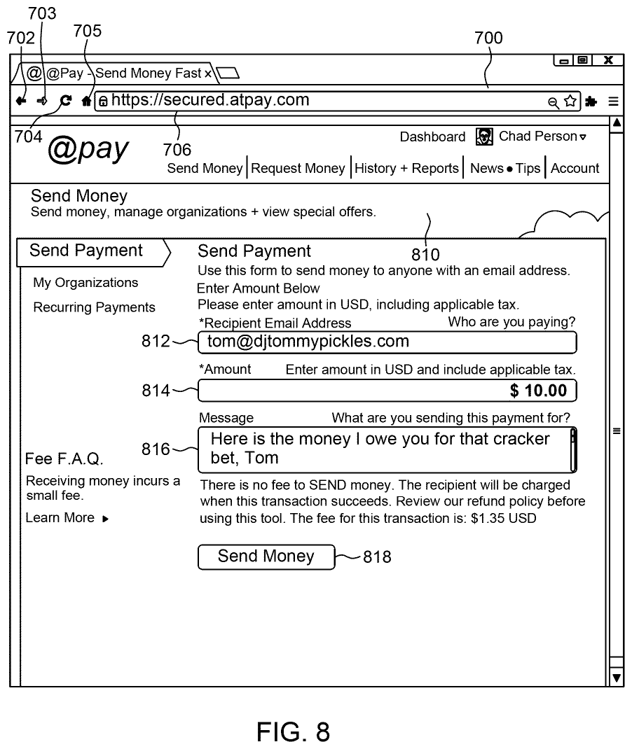

FIG. 8 shows an example web page 810 for the quick send feature. The quick send feature allows users to send a one-off payment to other individuals. As shown in FIG. 8, the web page 810 may include multiple input fields 812-818. An initiator, operating a customer device 150 may enter an email address in input field 812 and a payment amount in input field 814. Input field 816 allows for an optional message to the recipient. The payment server 140 generates an email message addressed to the email address entered in input field 812 notifying them that the initiator wishes to send them money. If the recipient is a registered member of the payment server 140, the email contains a button enabled with two-click ability to accept a payment. An example of this procedure is shown in FIG. 5, above. If the recipient is not a registered member of the payment server 140, the payment server 140 generates an email containing a button with a link to sign up for an account and accept the payment, as shown in FIG. 6, above.

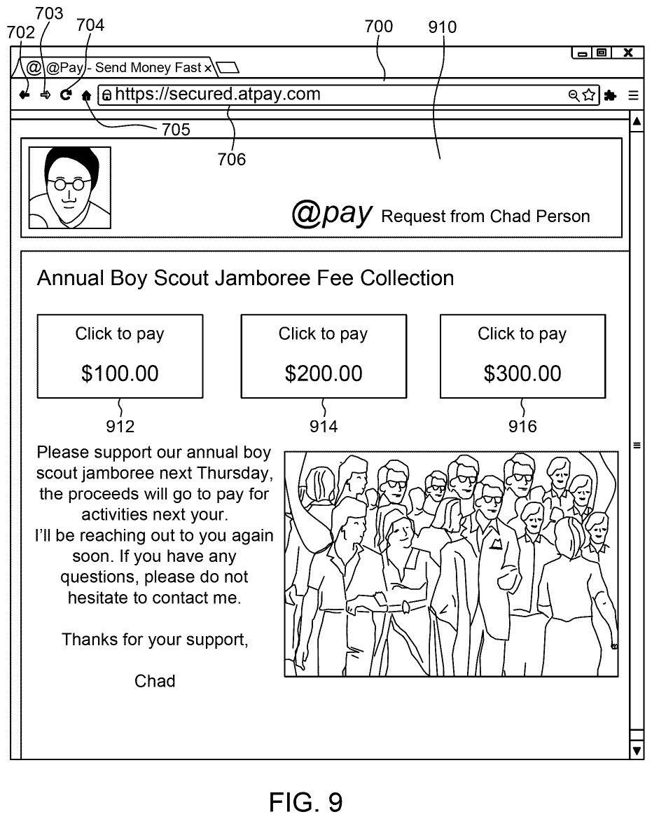

FIG. 9 shows an example web page 910 for the email blaster preview. The email blaster feature allows a user to configure and send email blasts to multiple users with multiple buttons. These email blasts may be used to send and receive payments. FIG. 9 shows a preview of an email that may be sent out using the peer to peer system described herein. As is shown in FIG. 9, the email generated may have multiple input fields 912-916, each of the input fields serve as pay buttons with different amounts. The flexibility of the email blaster allows a user to select the subject line, the from field, add images, include multiple pay buttons with different dollar amounts and send to larger groups.

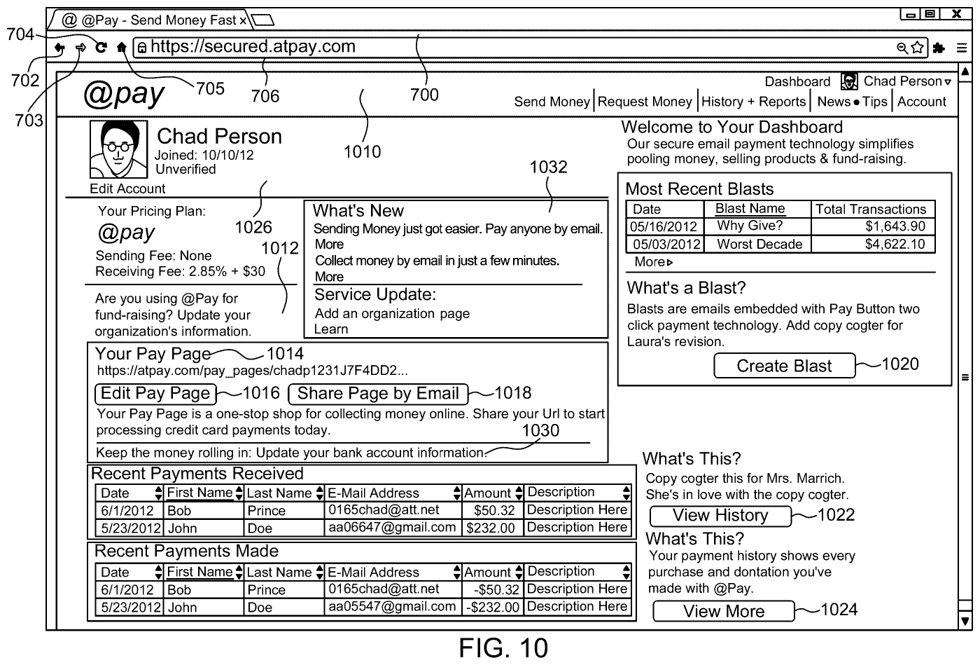

FIG. 10 shows an example web page 1010 for a dashboard, where a member may see the status of campaigns. As shown in FIG. 10, the web page 1010 may include multiple input fields 1012-1032. If the user is using the payment server 140 for fundraising, the user may select input field 1012 to update information regarding the organization for which the fundraising is occurring. The dashboard web page 1010 also provides input fields 1014-1018 that allow the user to visit their pay page, edit their pay page or share their pay page by email. To create an email blast, (e.g. shown in FIG. 9) the user may select input field 1020 to customize an email and mailing list for the blast. To monitor payment received history, the user may select input field 1022. To monitor payment made history, the user may select input field 1024. The user may edit their own account by selecting input field 1026. The user may update their bank information by selecting input field 1030. Further, as the selections are updated, the web browser unit 155 may update the web page 1010 to indicate additional, or more specific, questions that may be associated with the selections.

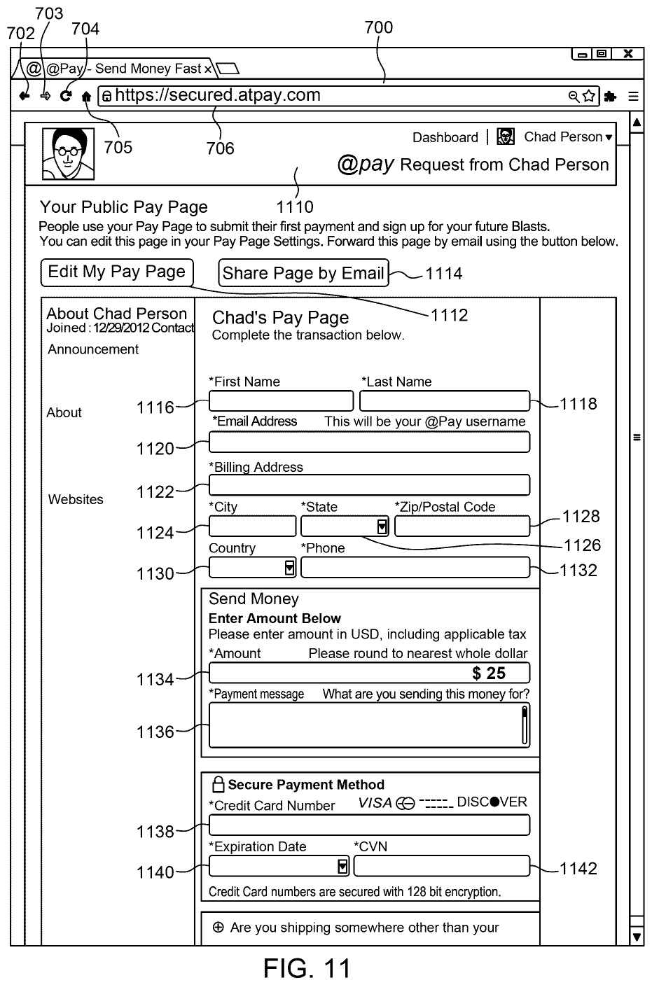

FIG. 11 shows an example web page 1110 for a public pay page associated with a user. Once the individual has registered as a member of the payment server 140 and has set up a profile the payment server 140 generates a public pay page that may be customized by the user. A user of a customer device 150 or 156 or other customer devices may access this web page 1110. As shown in FIG. 11, the web page 1110 may include multiple input fields 1112-1142. In this particular example, a user is logged in and viewing their own web page 1110. Because the user is viewing their own page, input fields 1112 and 1114 offer the user to edit the page and share the page via email, for a user not viewing their own page, these fields may not be presented. Input fields 1116-1142 allow a person to send money to the user associated with the pay page. Input fields 1116-1132 solicit a first name, last name, email address, billing address, city, state, zip code, country, and phone number of the sender. Input fields 1134 and 1136 solicit a payment amount and message to be sent. Input fields 1138-1142 solicit payment information for the payment identified in input field 1134. A similar page may be shown to allow the user associated with the page to send payments to other individuals. Further, as the selections are updated, the web browser unit 155 may update the web page 1110 to indicate additional, or more specific, questions that may be associated with the selections.

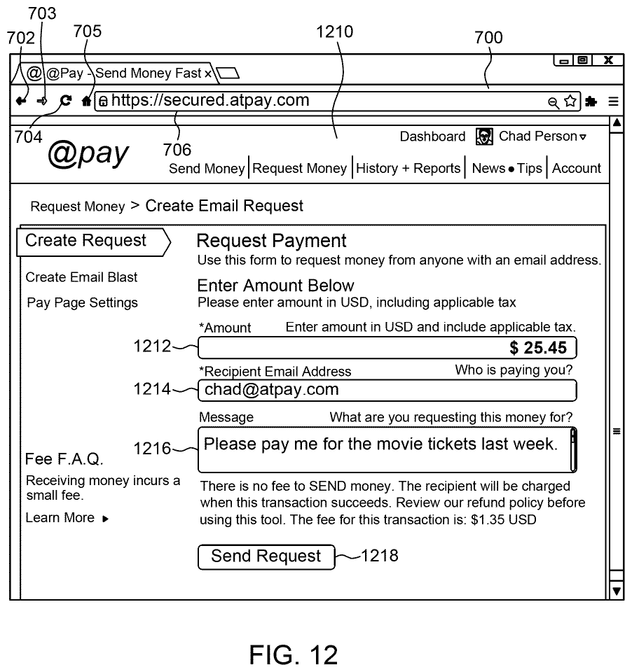

FIG. 12 shows an example web page 1210 for a quick request feature. The quick request feature allows a member to request a payment from another individual using the payment server 140 by filling out input fields 1212-1216. A user enters an email address in input field 1214 associated with the person from whom money is requested; a desired payment amount in input field 1212; and an optional message 1216. The payment server 140 generates an email message that is sent to the email address identified in input field 1214. The email message may include a two-click link or URL to pay page depending on the status of the recipient. If the recipient has a member account, that individual gets a two-click enabled email and the transaction may be performed according to the example process shown in FIG. 4. When user selects send on mailto email, the transaction is processed. If the recipient is a non-member, the email generated comprises a link to pay page to complete payment, according to the process shown in FIG. 3.

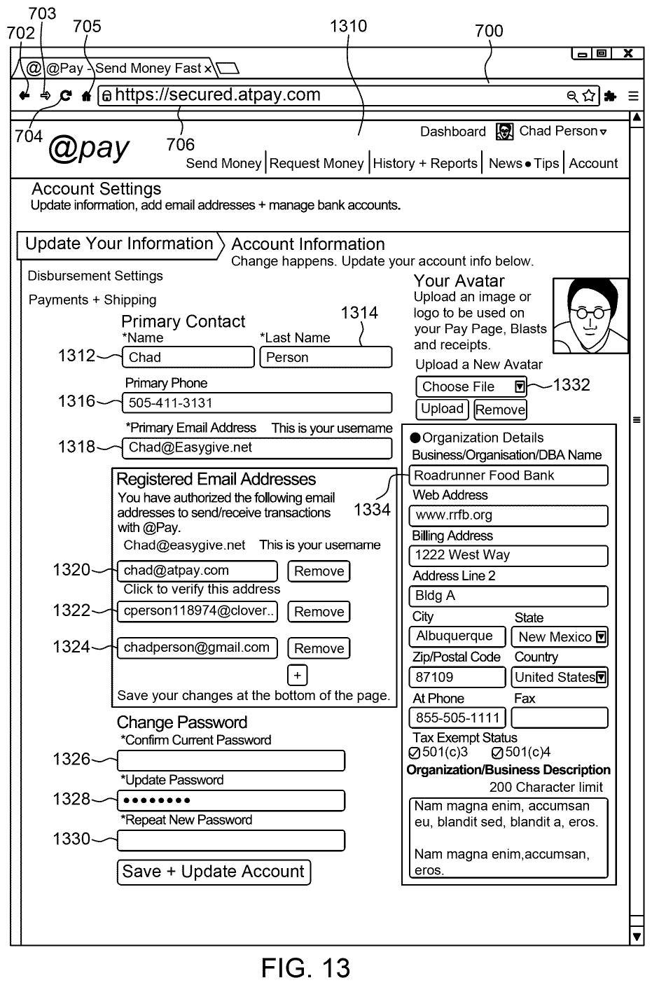

FIG. 13 shows an example web page 1310 for accessing a user's account settings. As shown in FIG. 13, the web page 1310 may include multiple input fields 1312-1334. Once a user has registered, the account settings web page 1310 is available to enter/update information associated with the user. Input fields 1312-1318 request basic information such as first name, last name, telephone, and a primary email address. Recognizing that a user may want to use multiple emails, input emails 1320-1324 allow a user to enter additional registered email addresses. In one embodiment, each registered address may be assigned to different payment options. Input fields 1326-1330 allow a user to change a password associated with the account. Input field 1332 allows a user to select an avatar (i.e. an image) to be displayed with the user's pay page. Input field 1334 solicits a user to enter organizational details, in case the account is associated with an organization. Further, as the selections are updated, the web browser unit 155 may update the web page 1310 to indicate additional, or more specific, questions that may be associated with the selections.

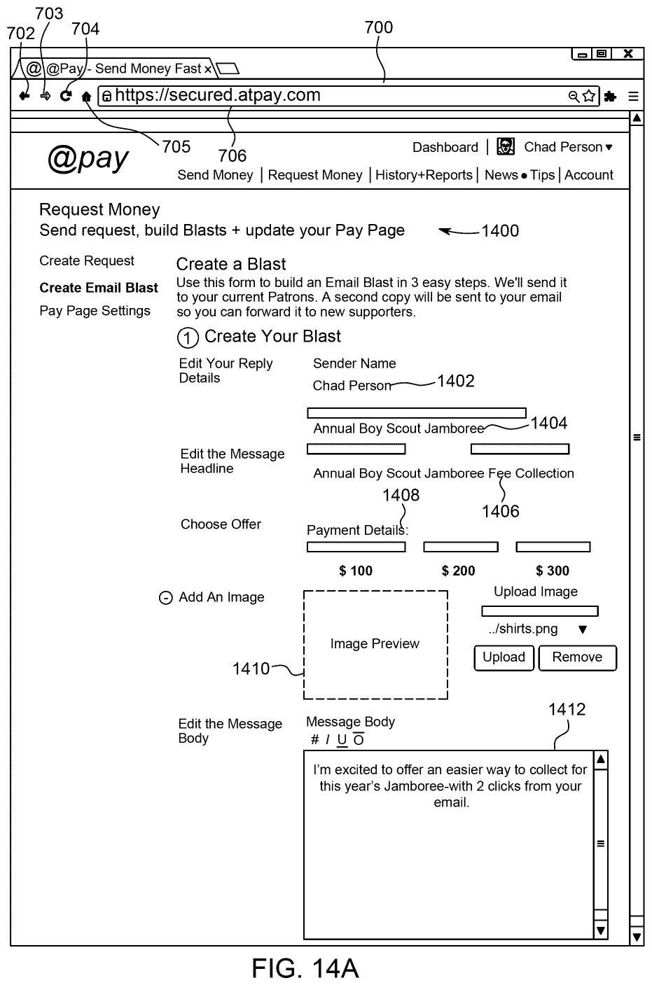

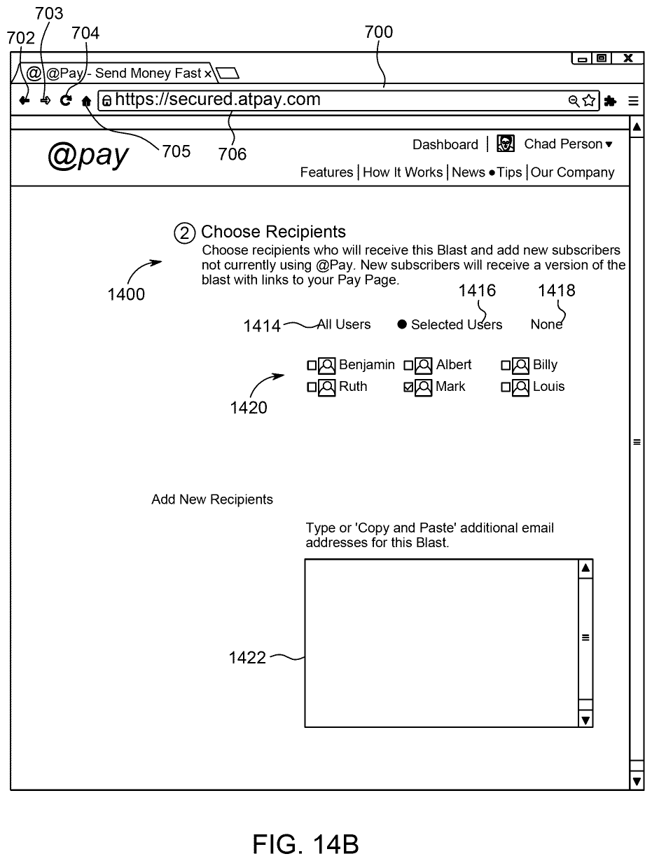

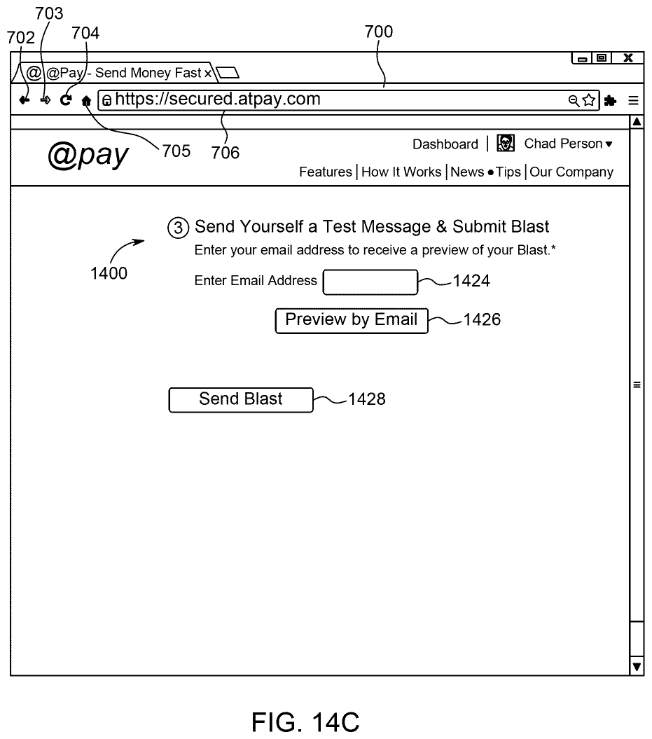

FIGS. 14A-14C show an example web page 1400 for generating an email blast. As shown in FIGS. 14A-14C, the web page 1400 may include multiple input fields 1402-1428. A member may access the email blaster feature. As shown in FIG. 14A, web page 1400 includes questions to solicit a member to enter information to create an email blast. Input fields 1402-1406 solicit a member, using a customer device 150, to enter sender name, subject line, and message headline information, to be used to generate email messages. Input field 1408 allows a member to enter payment amounts to be available in the blast. As shown in FIG. 14A, three payment amounts may be input, however, the web page 1400 may be updated as a member enters values to allow more. The amounts entered in input field 1408 may be converted into html buttons with embedded tokens, allowing the recipients to pay using the two-click process. Input field 1410 solicits a user to enter a picture into the email. Input field 1412 solicits a user to enter a message body for the email message that is to be generated.

As shown in FIG. 14B, once the member has input the contents of the email message to be generated, the member may select recipients of the email message. Input area 1414-1418 allows a member to select all users, selected users or none. If the user selects input field 1416 to send the email message to selected users, the member may select the specific users from the list shown in input field 1420. The member may also manually enter email addresses using input field 1422. Web page 1400 may also be configured to work with mail merge features allowing the member to upload a formatted list of email addresses.

As shown in FIG. 14C, once the member has input the email message information and selected the recipients, the member can preview the generated email message. A member may enter an email address in input field 1424 and select input field 1426 to preview the email message by email. Alternatively, the member may preview the email via a web page such as the web page shown in FIG. 9. Finally, if the member is ready to transmit the email message, the member may select input field 1428 and the payment server 140 may transmit the email message blast to the selected recipients. While FIGS. 14A-14C show a particular configuration of input fields, as the selections are updated, the web browser unit 155 may update the web page 1400 to indicate additional, or more specific, questions that may be associated with the selections.

While the examples described herein show a customer device 150 accessing the e-commerce features using a web browser, it should be understood that this is just one example. The methods described herein may be performed by different types of customer devices 150 such as a mobile phone, tablet, personal computer etc. The customer device 150 may perform e-commerce transactions using, e.g., a web browser, an app, a program installed on a personal computer, etc.

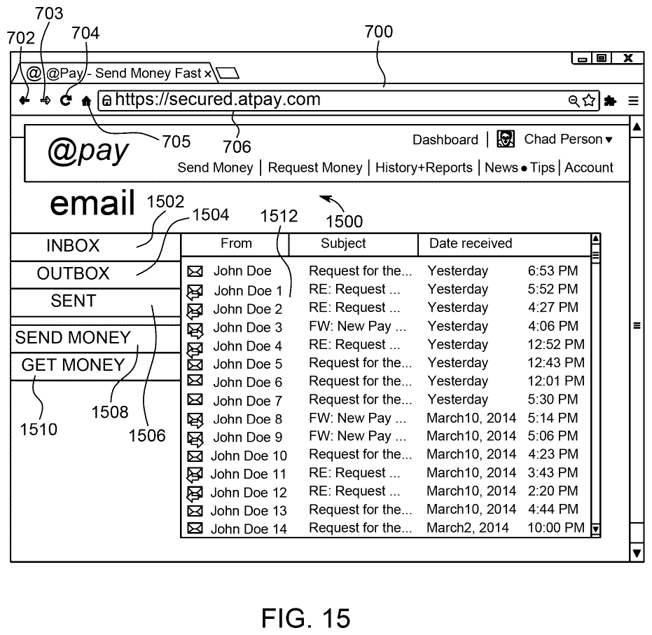

FIG. 15 shows an example web page 1500 for an embodiment where the payment server 140 is integrated with an email server. In this scenario, when the customer logs into their email account, they are logged into the payment server 140. The customer may be able to send money as a function of their email account. For example, this may be performed through web-based email or an application on the customer device 150. A member may sign into their email account and be presented with web page 1500. As shown in FIG. 15, the web page 1500 may include multiple input fields 1502-1512. Input fields 1502, 1504, and 1506 allow the member to access their email inbox, outbox, and sent messages. Input field 1512 allows the member to review their messages. Input fields 1508 and 1510 allow the member to send money and get money using the email based process as discussed above. As shown in FIG. 15, the member may be allowed to send and receive money in a manner that is integrated with their email account. Further, as the selections are updated, the web browser unit 155 may update the web page 1500 to indicate additional, or more specific, questions that may be associated with the selections. Referring back to FIG. 7, as the customer is signing up with the payment server 140, the customer may be also registering for an email account.

In another embodiment the information included in the URL Targeted Token and the Email Targeted Token may be in a single token. This token may include additional data including an identifier of an intended use. The e-commerce system 170 may receive the response email with this token. The e-commerce system 170 may parse the information in the token. The e-commerce system 170 may be configured to determine, based on the included the intended use data the parameters of the action to be taken. In this example a send money email may contain both the data for URL and Email Targeted Token data and also include information dictating that the processing maintains the parameters required by email targeted tokens. The e-commerce system 170 may decode the token using this intended use data to determine the process and what other data in the token is relevant.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or Bluray-Disc, or other type of device for electronic data storage.

Although the methods and features described above with reference to FIGS. 2-15 are described above as performed using the example system 100 of FIG. 1, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-15 may be used alone without the other features and elements or in various combinations with or without other features and elements. Sub-elements of the methods and features described above with reference to FIGS. 1-15 may be performed in any arbitrary order (including concurrently), in any combination or sub-combination.

What is claimed is:

1. A computer-implemented method for improving the security and usability of peer-to-peer financial transactions over electronic communication networks, the method comprising:
receiving, by a payment server comprising a processor and memory, an email message over a communication network, the email message originating from a responder and including a token embedded in a mailto hyperlink;
parsing, by the processor, the email message to extract the token from a predefined location within the message body;
decoding, by the processor, the token to retrieve transaction information including an intended responder email address and a transaction amount;
comparing, by the processor, the intended responder email address from the token with the actual sender address of the email message to authenticate the responder;
upon confirming a match between the addresses, executing, by the processor, a payment instruction by transmitting the transaction amount and requestor identity to a payment processing system,
wherein the transaction is executed based solely on the receipt and validation of the email response, without requiring the responder to access a web interface, enter login credentials, or perform multi-step authentication,
thereby reducing the latency, complexity, and vulnerability of conventional browser-based payment authorization mechanisms.

2. The method of claim 1, further comprising generating the token by the payment server in response to a request from the requestor received through a web-based user interface.

3. The method of claim 1, wherein the token comprises a digitally signed, encrypted string that includes a cryptographic hash of the responder's email address and a timestamp.

4. The method of claim 1, wherein the parsing of the email message comprises identifying the token within a predetermined delimiter or markup tag in the email body.

5. The method of claim 1, wherein the processor executes the payment instruction without invoking a login protocol or session management mechanism.

6. The method of claim 1, further comprising storing a transaction log entry including the responder's email address, requestor identifier, transaction amount, and timestamp in a database maintained by the payment server.

7. The method of claim 1, further comprising transmitting confirmation messages to both the requestor and the responder upon completion of the financial transaction.

8. The method of claim 1, further comprising rejecting the transaction and sending a failure notification to the responder when the token is expired or already used.

9. The method of claim 1, wherein the token includes metadata indicating an expiration time, and the processor determines whether the token remains valid based on a current time value.

10. A non-transitory computer-readable medium storing instructions that, when executed by a processor of a payment server, cause the payment server to perform the method of claim 1.

11. A system for enabling secure and low-friction peer-to-peer financial transactions via email communication, the system comprising:
a network interface configured to receive email messages transmitted over a communication network;
a memory storing executable instructions;
a processor configured to:
identify a token embedded in a received email message originating from a responder,
decrypt the token to extract transaction information including a transaction amount and an intended responder email address,
compare the intended responder email address from the token to the sender address of the email message to authenticate the responder, and
transmit payment instructions to a payment processing system to complete the transaction if the authentication is successful,
wherein the processor completes the transaction without requiring the responder to access a login page or submit authentication credentials through a user interface,
thereby improving upon conventional systems requiring interactive web-based login procedures.

12. The system of claim 11, wherein the token is extracted from a known markup tag or token-delimited string in the email body.

13. The system of claim 11, wherein the token is generated by the processor in response to a requestor-submitted form received through a hosted website or payment link.

14. The system of claim 11, wherein the memory stores a public key and private key pair used to encrypt and decrypt the token.

15. The system of claim 11, wherein the processor is configured to append a record of the transaction to a time-stamped transaction log maintained in the memory.

16. The system of claim 11, wherein the processor transmits an email confirmation to both the requestor and responder upon completion of the transaction.

17. The system of claim 11, wherein the processor is further configured to verify the validity of the token based on an expiration value encoded within the token payload.

18. The system of claim 11, wherein the system is configured to maintain a user profile for the requestor including a public payment page URL used to initiate generation of transaction tokens.

19. The system of claim 11, wherein the processor is configured to reject the transaction and transmit a rejection message when the email address extracted from the token does not match the sender of the received email.

20. The system of claim 11, wherein the transaction is completed based on a single email response action by the responder without requiring any multi-step challenge-response authentication sequence.
